(19) United States
(12) Patent Application Publication
(10) Pub. No.: US 2025/0375036 A1
(43) Pub. Date: Dec. 11, 2025

(54) SEAT DEVICE

(71) Applicant: TOYOTA BOSHOKU KABUSHIKI KAISHA, Aichi (JP)

(72) Inventor: Yasuhiro KATO, Toyota-shi (JP)

(73) Assignee: TOYOTA BOSHOKU KABUSHIKI KAISHA, Aichi (JP)

(21) Appl. No.: 19/226,225

(22) Filed: Jun. 3, 2025

(30) Foreign Application Priority Data
Jun. 7, 2024 (JP) 2024-092996

(51) Int. Cl. A47C 1/032; B60N 2/02; B60N 2/10

(52) U.S. Cl. CPC A47C 1/03294; B60N 2/02246; B60N 2/10

(57) ABSTRACT

Provided is a seat device including: a seat main body including a seat cushion and a seat back displaceable with respect to the seat cushion, the seat main body being capable of changing a posture between a normal posture in which the seat back is upright and a comfortable posture in which the seat back is reclined compared to the normal posture; a slide device that slidably supports the seat main body in a seat front-rear direction; and a reclining angle restriction device that regulates the maximum reclining angle of the seat back according to the position, in the seat front-rear direction, of the seat main body. The reclining angle restriction device is configured to set the maximum reclining angle when the position of the seat main body is positioned forward to be larger than the maximum reclining angle when the position of the seat main body is positioned rearward.

### CROSS-REFERENCE TO RELATED APPLICATIONS

The present application claims priority based on Japanese Patent Application No. 2024-092996 filed to Japanese Patent Office on Jun. 7, 2024, the content of Japanese Patent Application No. 2024-092996 is incorporated by reference in its entirety.

### BACKGROUND

The present disclosure relates to a seat device having a reclining function and a sliding function.

For example, Japanese Unexamined Patent Application Publication No. 2017-74514 (Patent Literature 1) describes an armchair, the entire chair of which slides forward in conjunction with the reclining of the seat back (backrest). In the invention described in Patent Literature 1, the reclining function of reclining the seat back and the sliding function operate in conjunction with each other.

### SUMMARY

For example, in a case where the seat device is installed in proximity to a wall or the like, if a user operates the reclining function alone, the seat back may unintentionally collide with the wall or the like. The present disclosure discloses an example of a seat device in view of this point.

It is desirable that the seat device includes, for example, at least one of the following components. The components are: a seat main body including a seat cushion and a seat back that is displaceable with respect to the seat cushion, the seat main body being capable of changing a posture between a normal posture in which the seat back is upright and a comfortable posture in which the seat back is reclined compared to the normal posture; a slide device that slidably supports the seat main body in a seat front-rear direction; and a reclining angle restriction device that restricts a maximum reclining angle of the seat back according to a position, in the seat front-rear direction, of the seat main body.

It is desirable that the reclining angle restriction device be configured to set the maximum reclining angle when the position of the seat main body is positioned forward to be larger than the maximum reclining angle when the position of the seat main body is positioned rearward.

As a result, in a case where the seat device is installed in proximity to a wall or the like, it is possible to avoid the seat back from unintentionally colliding with the wall or the like even if a user operates the reclining function alone.

The seat device may have, for example, the following configuration.

It is desirable that the reclining angle restriction device includes: a stopper that is displaced in conjunction with sliding displacement of the seat main body; and a contact portion that is provided on the seat back so as to be able to come into contact with the stopper, reclining displacement of the seat back being restricted when the contact portion comes into contact with the stopper.

It is desirable that the stopper be provided in a link mechanism that operates in conjunction with the sliding displacement of the seat main body.

It is desirable that the link mechanism includes: a first link whose one end side is rotatably coupled to a stationary portion; and a second link whose one end side is rotatably coupled to the other end side of the first link and whose other end side is, directly or indirectly, rotatably coupled to the seat main body.

In addition, it is desirable that: an electric motor that generates a drive force for displacing the seat back be provided; and the reclining angle restriction device includes a sensor device that detects a relationship between a position of the seat main body and a reclining angle of the seat back, and a controller that uses a detection signal of the sensor device to stop the electric motor.

It is desirable that the sensor device includes a sensor that detects the position of the seat back, and a sensor displacement mechanism that displaces the sensor in conjunction with the sliding displacement of the seat main body.

It is desirable that the sensor displacement mechanism be configured by a link mechanism having a first link and a second link, in which one end side of the first link is rotatably coupled to a stationary portion, and one end side of the second link is rotatably coupled to the other end side of the first link and the other end side thereof is, directly or indirectly, rotatably coupled to the seat main body.

### BRIEF DESCRIPTION OF THE DRAWINGS

An example embodiment of the present disclosure will be described hereinafter with reference to the accompanying drawings, in which:

FIG. 1 is a view illustrating a seat device.

FIG. 2 is a view illustrating a seat device.

FIG. 3 is a view illustrating a seat device.

FIG. 4 is a block diagram of a control system.

FIG. 5 is a view illustrating a seat device.

FIG. 6 is a view illustrating a seat device.

### DETAILED DESCRIPTION OF EXEMPLARY EMBODIMENTS

Embodiments of the following invention illustrate examples of embodiments falling within the technical scope of the present disclosure. That is, invention-specific matters and the like described in the claims are not limited to the specific configurations, structures, and the like described in the following embodiments.

Arrows indicating directions assigned to each view, oblique lines, and the like are illustrated in order to facilitate understanding of the relationships between the respective views, the shapes of members or portions, and the like.

The present disclosure is not limited to the directions assigned to each view. Unless otherwise specified, such as by indicating ‘one’, at least one of the members or portions, which are described by being denoted at least with reference numerals, is provided.

### First Embodiment

### <1. Outline of Vehicle Seat>

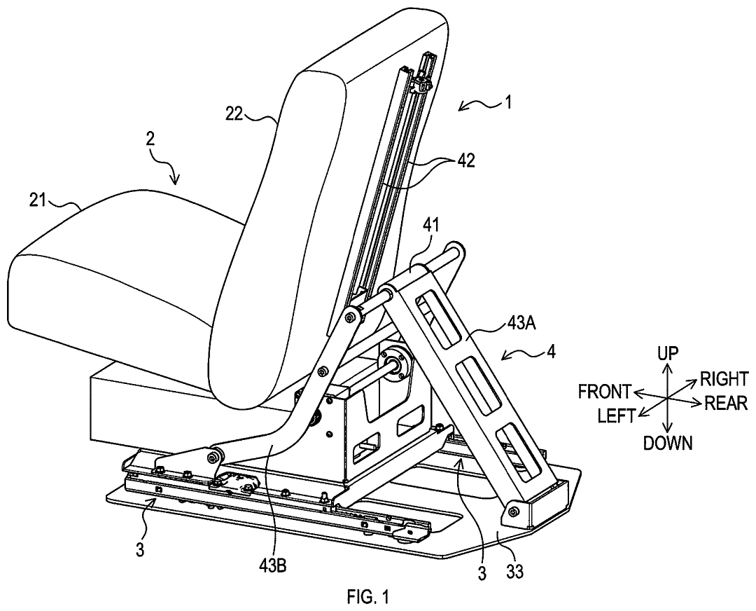

As illustrated in FIG. 1, a seat device 1 includes a seat main body 2, a slide device 3, and a reclining angle restriction device 4. The seat main body 2 is a chair on which a user of the seat device 1 sits.

### <Seat Main Body>

The seat main body 2 includes a seat cushion 21 and a seat back 22. The seat cushion 21 is a portion that supports the buttocks of a seated person. The seat back 22 is a portion that supports the back of a seated person.

The seat back 22 is coupled to the seat cushion 21 so as to be displaceable with respect to the seat cushion 21. Specifically, the posture of the seat back 22 can be changed between a normal posture and a comfortable posture. Hereinafter, the posture changing function of the seat back 22 is referred to as a reclining function.

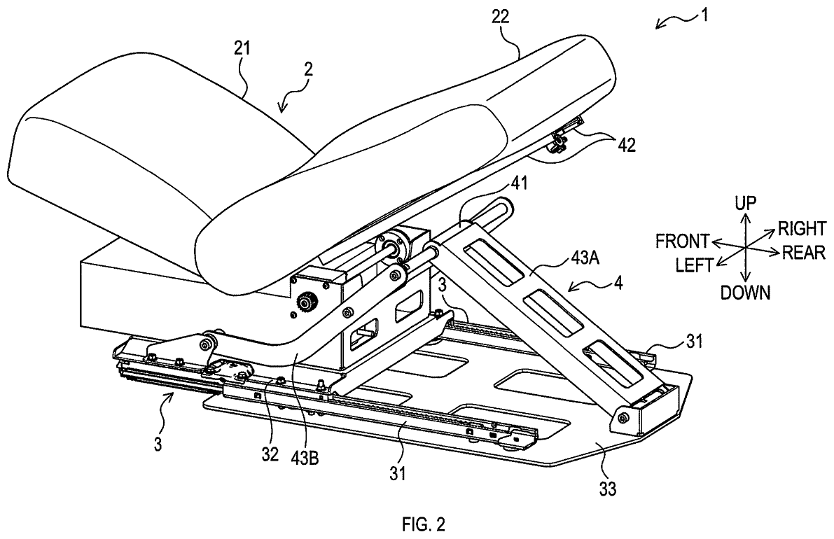

The normal posture refers to a posture in which the seat back 22 is upright, as illustrated in FIG. 1. The comfortable posture refers to a posture in which the seat back 22 is reclined compared to the normal posture, as illustrated in FIG. 2. The seat cushion 21 according to the present embodiment can exhibit a tilt function.

The tilt function is a mechanism that changes a position, in the up-down direction, of the front end side of the seat cushion 21 with respect to the rear end side of the seat cushion 21. The front end side of the seat cushion 21 illustrated in FIG. 2 is raised compared to the seat cushion 21 illustrated in FIG. 1 by the tilt function.

### <Slide Device>

The slide device 3 is a device that slidably supports the seat main body 2 in the seat front-rear direction. The seat main body 2 is supported by two slide devices 3, as illustrated in FIG. 2.

The first slide device 3 is disposed on a first end side in the seat width direction. The second slide device 3 is disposed on a second end side in the seat width direction. The two slide devices 3 have the same structure.

Each of the slide devices 3 includes a fixed rail 31 and a movable rail 32. Each fixed rail 31 is a rail member fixed to a stationary base plate 33. Each movable rail 32 is a member slidably coupled to the corresponding fixed rail 31.

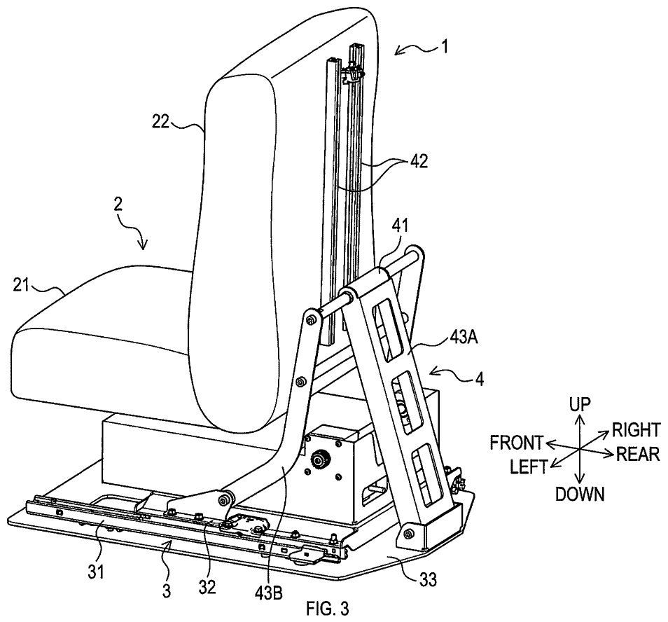

The seat main body 2 is coupled to each movable rail 32. As a result, the seat main body 2 can be displaced along the longitudinal direction of the fixed rail 31 with respect to the base plate 33. FIG. 2 illustrates a state in which the seat main body 2 is displaced to the foremost position. FIG. 3 illustrates a state in which the seat main body 2 is displaced to the rearmost position.

### <Reclining Angle Restriction Device>

The reclining angle restriction device 4 is a device that restricts the maximum reclining angle of the seat back 22 according to the position, in the seat front-rear direction, of the seat main body 2. Specifically, the reclining angle restriction device 4 restricts the displacement of the seat back 22 such that the further forward the seat main body 2 is positioned, the larger the maximum reclining angle becomes.

In other words, the reclining angle restriction device 4 restricts the displacement of the seat back 22 such that the further rearward the seat main body 2 is positioned, the smaller the maximum reclining angle becomes. The reclining angle refers to the inclination angle of the seat back 22 with a state in which the seat back 22 is upright as a reference (0).

### <Control System>

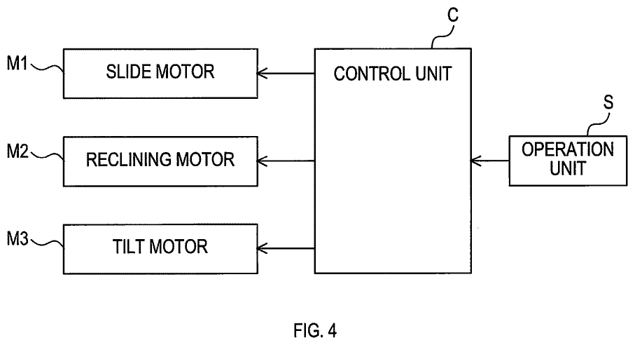

As illustrated in FIG. 4, the seat device 1 includes a slide motor M1 for electrically operating each of the slide devices 3, a reclining motor M2 for the reclining function, a tilt motor M3 for the tilt function, a controller C, and an operation device S.

The slide motor M1 generates a drive force for activating each movable rail 32. The reclining motor M2 generates a drive force for executing the reclining function. The tilt motor M3 generates a drive force for executing the tilt function.

The controller C controls the operations of the slide motor M1, the reclining motor M2, and the tilt motor M3. The operation device S is an input device operated by a user. The controller C controls the operation of each of the motors M1 to M3 according to the operation contents of the operation device S and specific programs.

### <2. Details of Reclining Angle Restriction Device>

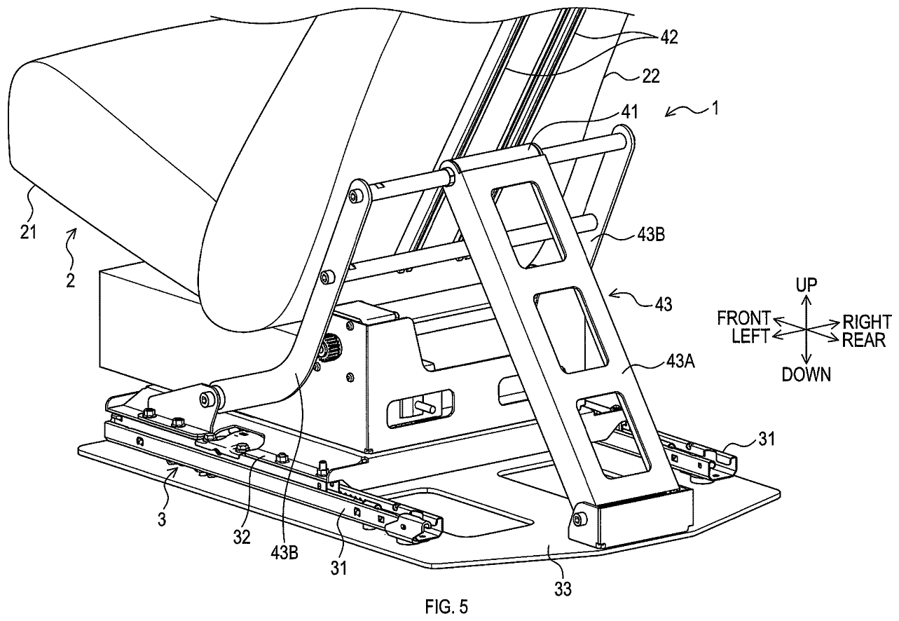

The reclining angle restriction device 4 mechanically restricts the maximum reclining angle. As illustrated in FIG. 5, the reclining angle restriction device 4 includes a stopper 41, a contact portion 42, and a link mechanism 43.

The stopper 41 is a member that is displaced in conjunction with the sliding displacement of the seat main body 2. The stopper 41 is provided in the link mechanism 43. The link mechanism 43 includes a first link 43A and a second link 43B.

The first end side of the first link 43A is rotatably coupled to a stationary portion. The first end side of the second link 43B is rotatably coupled to the second end side of the first link 43A. The second end side of the second link 43B is, directly or indirectly, rotatably coupled to the seat main body 2.

The lower end side of the first link 43A is rotatably coupled to the rear end side of the base plate 33. The upper end side of the second link 43B is rotatably coupled to the upper end side of the first link 43A, and the lower end side is rotatably coupled to the movable rail 32.

The link mechanism 43 includes two second links 43B. The upper end side of each of the second links 43B is rotatably coupled to the upper end side of the first link 43A. The lower end side of each of the second links 43B is rotatably coupled to the corresponding movable rail 32.

The stopper 41 is provided at the top of the triangle formed by the first link 43A and the two second links 43B. As a result, when the seat main body 2 is slidably displaced, the stopper 41 is displaced in the up-down direction in conjunction therewith.

The contact portion 42 is a portion that is provided on the seat back 22 and is able to come into contact with the stopper 41. When the stopper 41 comes into contact with the contact portion 42, the reclining displacement of the seat back 22 is mechanically restricted.

When detecting that the stopper 41 has come into contact with the contact portion 42, the controller C stops the reclining motor M2. The controller C detects the contact by a change in the current value supplied to the reclining motor M2.

### <3. Features of Seat Device>

The seat device 1 includes the reclining angle restriction device 4 that restricts the maximum reclining angle of the seat back 22 according to the position, in the seat front-rear direction, of the seat main body 2.

As a result, in a case where the seat device 1 is installed in proximity to a wall or the like, it is possible to avoid the seat back 22 from unintentionally colliding with the wall or the like even if a user operates the reclining function alone.

### Second Embodiment

The reclining angle restriction device 4 according to the first embodiment described above is configured to mechanically restrict the maximum reclining angle. On the other hand, a reclining angle restriction device 4 according to the second embodiment is configured to electrically restrict the maximum reclining angle. The following description relates to differences from the seat device 1 according to the first embodiment described above.

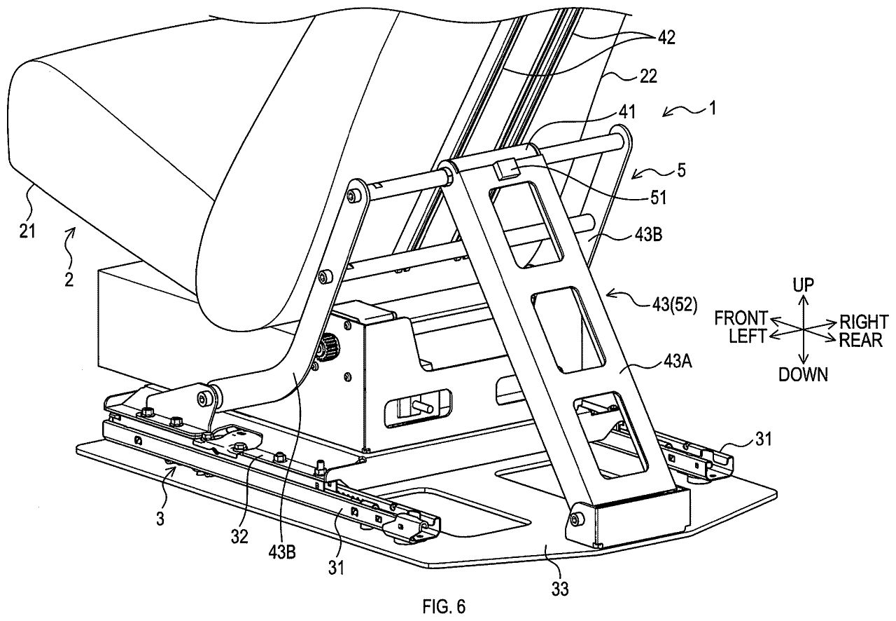

As illustrated in FIG. 6, the reclining angle restriction device 4 includes a sensor device 5. The sensor device 5 detects the relationship between the position of a seat main body 2 and the reclining angle of a seat back 22.

The sensor device 5 includes a sensor 51 and a sensor displacement mechanism 52. The sensor 51 detects the position of the seat back 22. For example, the sensor 51 includes a proximity sensor.

The sensor displacement mechanism 52 is a mechanism that displaces the sensor 51 in conjunction with the sliding displacement of the seat main body 2. For example, the sensor displacement mechanism 52 is a mechanism having the same configuration as the link mechanism 43 according to the first embodiment.

The sensor 51 is provided in the sensor displacement mechanism 52, that is, provided at the top of the triangle formed by the first link 43A and the two second links 43B of the link mechanism 43. As a result, when the seat main body 2 is slidably displaced, the sensor 51 is displaced at least in the up-down direction in conjunction with the displacement.

Then, a controller C uses the detection signal of the sensor device 5 to stop a reclining motor M2. When the distance between the sensor 51 and the seat back 22 becomes equal to or less than a specific value, the sensor 51 inputs a signal indicating that to the controller C.

When receiving the signal, the controller C stops supplying power to the reclining motor M2. The reclining angle restriction device 4 includes a stopper 41 and a contact portion 42. This is to restrict the seat back 22 from reclining beyond the maximum reclining angle by some force after the supplying power is stopped.

The same components and the like as those of the first embodiment described above are denoted by the same reference numerals as those of the first embodiment described above. Therefore, redundant description is omitted in the second embodiment.

### OTHER EMBODIMENTS

The sensor device 5 according to the second embodiment described above includes the sensor 51 and the sensor displacement mechanism 52. However, the present disclosure is not limited thereto. For example, the sensor device may be constituted by the sensor 51 and a position sensor that detects the position of the seat main body 2. The sensor 51 in this configuration may be an angle sensor that detects the angle of the seat back 22.

The sensor 51 according to the second embodiment described above is a proximity sensor. However, the present disclosure is not limited thereto. For example, the sensor 51 may be configured by a limit switch.

The sensor displacement mechanism 52 according to the second embodiment described above has the same configuration as the link mechanism 43. However, the present disclosure is not limited thereto. For example, a sensor displacement mechanism that electrically displaces the sensor 51 according to the position of the seat main body 2 may be used.

The link mechanism 43 and the sensor displacement mechanism 52 according to the second embodiment described above are configured by the first link 43A and the second link 43B. However, the present disclosure is not limited thereto. For example, a mechanical mechanism having another configuration may be used.

In the first and second embodiments described above, the maximum reclining angle is restricted according to the slide position of the seat main body 2. However, the present disclosure is not limited thereto. For example, a sensor that detects the distance between the upper end of the seat back 22 and the wall may be provided, and the supplying power to the reclining motor M2 may be stopped using a detection signal of the sensor.

The seat device 1 according to the first embodiment described above is an electric type. However, the present disclosure is not limited thereto. For example, a manual type may be used, or a configuration in which an electric type and a manual type are switchable may be used.

Furthermore, the present disclosure is not limited to the above-described embodiments as long as it meets the gist of the disclosure described in the above-described embodiments. Therefore, a configuration in which at least two of the plurality of embodiments described above are combined, or a configuration in which any of the components illustrated in the drawings or the components described with reference numerals in the embodiments described above is eliminated, may be used.

What is claimed is:

1. A seat device comprising:
a seat main body including a seat cushion and a seat back that is displaceable with respect to the seat cushion, the seat main body being capable of changing a posture between a normal posture in which the seat back is upright and a comfortable posture in which the seat back is reclined compared to the normal posture;
a slide device that slidably supports the seat main body in a seat front-rear direction; and
a reclining angle restriction device that restricts a maximum reclining angle of the seat back according to a position, in the seat front-rear direction, of the seat main body, wherein
the reclining angle restriction device is configured to set the maximum reclining angle when the position of the seat main body is positioned forward to be larger than the maximum reclining angle when the position of the seat main body is positioned rearward.

2. The seat device according to claim 1, wherein
the reclining angle restriction device includes: a stopper that is displaced in conjunction with sliding displacement of the seat main body; and a contact portion that is provided on the seat back so as to be able to come into contact with the stopper, the contact portion restricting reclining displacement of the seat back when coming into contact with the stopper.

3. The seat device according to claim 2, wherein the stopper is provided in a link mechanism that operates in conjunction with the sliding displacement of the seat main body.

4. The seat device according to claim 3, wherein
the link mechanism includes:
a first link whose one end side is rotatably coupled to a stationary portion; and a second link whose one end side is rotatably coupled to an other end side of the first link and whose other end side is, directly or indirectly, rotatably coupled to the seat main body.

5. The seat device according to claim 1, comprising an electric motor that generates a drive force for displacing the seat back, wherein
the reclining angle restriction device includes:
a sensor device that detects a relationship between a position of the seat main body and a reclining angle of the seat back; and
a controller that uses a detection signal of the sensor device to stop the electric motor.

6. The seat device according to claim 5, wherein
the sensor device includes:
a sensor that detects a position of the seat back; and
a sensor displacement mechanism that displaces the sensor in conjunction with the sliding displacement of the seat main body.

7. The seat device according to claim 6, wherein
the sensor displacement mechanism includes a link mechanism having a first link and a second link,
one end side of the first link is rotatably coupled to a stationary portion, and
one end side of the second link is rotatably coupled to the other end side of the first link, and the other end side is, directly or indirectly, rotatably coupled to the seat main body.
